(19) United States
(12) Patent Application Publication
(10) Pub. No.: US 2014/0267171 A1
(43) Pub. Date: Sep. 18, 2014

(54) DISPLAY DEVICE TO RECOGNIZE TOUCH

(71) Applicant: Hyundai Motor Company, (US)

(72) Inventor: Sung-Un Kim, Yongin (KR)

(73) Assignee: HYUNDAI MOTOR COMPANY, Seoul (KR)

(21) Appl. No.: 13/840,806

(22) Filed: Mar. 15, 2013

(51) Int. Cl. G06F 3/042

(52) U.S. Cl. CPC G06F 3/0421
USPC 345/175

(57) ABSTRACT

Disclosed is a display device configured to recognize touch on a display having various shapes matching with a design inside a vehicle. The display device configured to recognize touch includes a screen and a visible light generator, controlled by a processor, configured to project a predetermined image with visible light to the screen. In addition, the display includes an infrared light generator configured to generate scattering light according to user touch with an infrared light source; a projector configured to project the visible light from the visible light generator and the infrared light source from the infrared light generator to the screen; and an optical sensor configured to detect the scattering light, all controlled by the processor.

### BACKGROUND

1. Field of the Invention

The present invention relates to a display device configured to recognize touch, and more particularly, to a display device configured to recognize touch on a display having various shapes matching a design inside a vehicle, to thereby reduce a manufacturing cost by configuring the display device by relatively simple constituent elements.

2. Description of the Related Art

Recently, various input devices such as a key panel input device, a jog dial, and a touch screen capable of inputting commands with respect to various functions of the vehicle have been developed in response to improvement of vehicle functions. In recent years, a touch screen has actively been applied to an Audio-Video-Navigation (AVN) cluster.

However, in general, the developed touch screens are a rectangular touch screen installed at a front surface of a driver side, thus the space in the interior of the vehicle is not efficiently utilized, it may be difficult to match the display device design with a curved design of the vehicle, a design cost of adjusting the display module to a curved surface may increase, it may be difficult to recognize touch of a general object such as gloves or a pen, and touch error may occur due to the form of a flat touch screen.

Accordingly, there is a need for a display device which may be installed at an optional curved surface inside the vehicle, may easily match with a curved design inside the vehicle, and may simultaneously display predetermined information and perform touch recognition to increase convenience of vehicle running.

### SUMMARY

The present invention provides a display configured to recognize touch having various shapes corresponding to a display design in a vehicle. In addition, the display according to the present invention may reduce manufacturing costs and may increase interior space of a vehicle.

The present invention further provides a display device capable of recognizing multi-touch and touch using a general object (e.g., a pen or a pointer) as well as a human finger.

In one aspect of the present invention, a display device configured to recognize touch includes: a screen; a visible light generator configured to project a predetermined image with visible light to the screen; an infrared light generator configured to generate scattering light according to user touch with an infrared light source; a projector configured to project the visible light from the visible light generator and the infrared light source from the infrared light generator to the screen; and an optical sensor configured to detect the scattering light, all of which are controlled by a processor that is typically part of a controller installed in the vehicle.

The visible light generator may combine at least one generator selected from a group consisting of: an RGB (red, green, blue) light source, a Cyan light source, a Magenta light source, and a yellow light source to project the combined light source. Additionally, the visible light and the infrared light source may be input to the projector through a beam splitter.

Furthermore, the infrared light source may be configured to scan the screen at a predetermined time interval to generate the scattering light at a touched point. The projector may include a timing generator configured to calculate coordinates (e.g., location) on the screen of the scattering light detected by the optical sensor. In addition, the scattering light may be detected by the timing generator in a time division scheme. A peripheral line of the screen may include a straight line or a curved line.

According to another exemplary embodiment, the present invention provides a vehicle in which the display device configured to recognize touch is mounted.

In yet another exemplary embodiment, the present invention provides a method of recognizing touch using a display device configured to recognize touch. The method includes projecting, by a processor, a predetermined image to a screen with visible light; generating, by the processor, scattering light at a touched point by scanning through an infrared light source; detecting, by the processor, the scattering light using an optical sensor; and calculating, by the processor, coordinates on the screen of the scattering light to recognize the touched point using a timing generator controlled by the processor.

According to the display device configured to recognize touch of the present invention, touch recognition is possible when the screen is has either a flat shape or a curved shape to match a design inside the vehicle.

Further, the present invention provides a method of touch recognition without using a camera, an image processor, and an infrared illuminator required in a touch recognition scheme using an existing camera, thus the display device configured to recognize touch in the present invention may be manufactured at a lower cost while increasing the interior space of the vehicle at the same time.

Since the present invention recognizes presence of a touch by scanning the screen using an infrared light source in a time division scheme, multi-touch may be recognized. In addition, since the present invention uses a touch recognition scheme by a projector, touch using a general object such as gloves or a pen as well as a human finger may be recognized.

According to the present invention, since a display image pixel spatially matches with an infrared scanning pixel, touch recognition distortion due to a curved surface does not exist, thereby increasing the reliability of touch recognition with respect to disturbance due to solar light.

### BRIEF DESCRIPTION OF THE DRAWINGS

The objects, features and advantages of the present invention will be more apparent from the following detailed description in conjunction with the accompanying drawings, in which:

FIG. 1 is an exemplary block diagram illustrating a configuration of a display device configured to recognize touch according to the related art;

FIG. 2 is an exemplary block diagram illustrating a configuration of a display device configured to recognize touch according to an exemplary embodiment of the present invention;

FIG. 3 is an exemplary diagram illustrating the display device configured to recognize touch according to an exemplary embodiment of the present invention;

FIG. 4 is an exemplary diagram illustrating an example of detecting scattering light generated by touch and infrared light scanning according to an exemplary embodiment of the present invention;

FIG. 5 is an exemplary diagram illustrating a touch detection signal generated through the infrared light scanning according to an exemplary embodiment of the present invention;

FIG. 6 is an exemplary diagram illustrating a vehicle in which a display device configured to recognize touch including a screen having a curved shape is mounted according to an exemplary embodiment of the present invention; and

FIG. 7 is an exemplary flowchart illustrating a method of recognizing touch using the display device configured to recognize touch according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Exemplary embodiments of the present invention are described with reference to the accompanying drawings in detail. Terms and words used in the specification and the claims shall not be interpreted as commonly-used dictionary meanings, but shall be interpreted as to be relevant to the technical scope of the invention based on the fact that the inventor may property define the concept of the terms to explain the invention in best ways. Therefore, the embodiments and the configurations depicted in the drawings are illustrative purposes only and do not represent all technical scopes of the embodiments, so it should be understood that various equivalents and modifications may exist at the time of filing this application.

FIG. 1 is an exemplary block diagram illustrating a configuration of a display device configured to recognize touch according to the related art. The display device configured to recognize touch mounted in a vehicle according to the related art as illustrated in FIG. 1, includes an image processor 21 configured to process a captured image 20 and a memory 22 configured to store the processed image as well as an infrared (IR) camera 17, an infrared illuminator 18, and a projector 19. Specifically, the projector 19 is configured to project a predetermined image. The infrared illuminator 18 is configured to illuminate infrared light to a full screen. The infrared camera 17 is configured to capture an image reflected by a finger of a user. In this way, the touch is recognized by processing the image using the image processor 21.

As described above, since the display device configured to recognize touch according to the related art must include the IR camera 17, the image processor 21, and the memory 22, a manufacturing cost may increase. As shown in FIG. 1, the screen has a complex structure which includes a hard coat layer, a diffusion sheet, an optical sheet, and a polycarbonate plate. Therefore, touch recognition may fail due to generation of black stripe.

FIG. 2 is an exemplary block diagram illustrating a configuration of a display device configured to recognize touch according to an exemplary embodiment of the present invention, and FIG. 3 is an exemplary diagram illustrating the display device configured to recognize touch according to an exemplary embodiment of the present invention.

The present invention provides a display device configured to recognize touch and may include a projector 36 and a curved screen 31 of a curved display, wherein the projector, executed by a processor, is configured to project visible light to display an image and an infrared light source to recognize touch to the curved screen 31. When the infrared light source is scanned by the projector 36 and infrared lights are scattered by touch of a user, the optical sensor 37, executed by the processor, may determine whether scattering light is generated and may acquire the timing of the scattering light. The timing of the scattering light may be converted into X-Y coordinates on a screen to recognize a touched point.

In other words, a display device configured to recognize touch according to the present invention may include a screen 31, a visible light generator 34, executed by the processor, configured to project a predetermined image with visible light to the screen 31, an infrared light generator 35, executed by the processor, configured to generate scattering light according to user touch with an infrared light source, a projector 36, executed by the processor, configured to project the visible light from the visible light generator 34 and the infrared light source from the infrared light generator 35 to the screen 31, and an optical sensor 37, executed by the processor, may detect the scattering light.

The screen 31 may be a flat screen. Alternatively, the screen 31 may be a curved screen since the screen 31 has a structure which performs image projection and touch recognition by the projector 36. In addition, the screen 31 may adopt a double curved screen as well as a simple curved screen.

The visible light generator 34 and the infrared light generator 35, both executed by the processor, may be configured to output the visible light and the infrared light source to the projector 36, respectively. To separate the paths of the visible light and the infrared light source, the visible light and the infrared light source may be input to the projector 36 through a beam splitter 33.

Moreover, the visible light generator 34 may selectively generate an RGB light source, a Cyan light source, a Magenta light source, or a yellow light source to project a predetermined image. In other words, according to the present invention, the visible light generator 34 may be configured to project a color image by the RGB light source or a white image by the Cyan light source as necessary.

As described above, the image configured to transfer predetermined information to a user may be projected on the screen with the visible light, and the infrared light source may scan the screen 31 to recognize touch on a predetermined point of the image. In other words, when the user touches a predetermined point on the screen 31, an infrared light input in a time division scheme may be scattered and an optical sensor 27 may detect the generated scattering light 39 to thereby recognize the touch.

In particular, the information about the scattering light detected by the optical sensor 37 may be input to a timing generator 40 of the projector 36. The timing generator 40, executed by the processor, may be configured to calculate the timing and coordinates on the screen 31 of the scattering light 39. Further, when a touched point on the screen 31 is determined, an image at the determined touched point may be represented on the screen.

The scattering light 39 may be detected by the timing generator 40 in a time division scheme. Accordingly, multi-touch where two points are touched may be recognized.

The display device configured to recognize touch configured as above may be mounted in the vehicle. Since a screen 31 having various shapes may be utilized, the display device configured to recognize touch may match with various designs inside the vehicle.

FIG. 4 is an exemplary diagram illustrating an example of detecting scattering light generated by touch and infrared light scanning according to an exemplary embodiment of the present invention.

Specifically, the screen 31 according to the present invention may be formed by bonding a project film 31′ to a known screen material. The screen is different from the related art, because a hard coat layer, a diffusion sheet, an optical sheet, and a polycarbonate plate are not required, thereby reducing a manufacturing.

As illustrated in FIG. 4, when the user touches a predetermined point on the screen 31, the projector 36 may be configured to scan the screen 31 with the infrared light source to generate the scattering light 39. The scattering light 39 may be collected by the optical sensor 37, and the collected scattering light 39 may be input to the timing generator 40 in a real-time manner to thereby calculate the X-Y coordinates at the touch point.

FIG. 5 is an exemplary diagram illustrating a touch detection signal generated through the infrared light scanning according to an exemplary embodiment of the present invention.

The present invention may use a scheme to separately scan the screen at a predetermined time interval instead of simultaneously scanning a full screen. Accordingly, when at least two multi-touches occur on the screen 31, scattering lights 39 may be generated at a predetermined time interval. That is, as illustrated in FIG. 5, the scattering lights 39 may be generated at a time interval of for example, 7 ms or 9 ms, which are detected in a time division scheme to allow the timing generator 40 to calculate the touched point, thereby performing a command input by the user.

FIG. 6 is an exemplary diagram illustrating a vehicle in which a display device configured to recognize touch including a screen having a curved shape is mounted according to an exemplary embodiment of the present invention.

According to the present invention, since the predetermined image is projected and the screen scanned by the infrared light may be in various forms, the screen may conform with a design inside the vehicle. In other words, the screen having various curved shapes may apply to a side surface of a driver side as well as a front surface of the driver side, thereby increasing design options.

FIG. 7 is an exemplary flowchart illustrating a method of recognizing touch using the display device configured to recognize touch according to an exemplary embodiment of the present invention.

First, a predetermined image may be projected, by a processor, to a screen 31 with visible light (S71). When the predetermined image is projected to a flat or curved screen, a user may touch the screen using a finger or a general object to perform a predetermined function.

Furthermore, scattering light may be generated at a touched point of the user through scanning by an infrared light source, executed by the processor (S72). In other words, when a finger of the user or the general object such as gloves or a pen touches the screen 31, the scattering light 39 may be generated by the infrared light scanning.

Additionally, an optical sensor 37, executed by the processor, may be configured to detect the scattering light (S73). The optical sensor 37 may collect the scatting light 39 to transfer corresponding information to a timing generator 40 in the projector 36.

Subsequently, the timing generator 40, executed by the processor, may be configured to calculate coordinates on the screen 31 of the scattering light 39 to recognize a touched point (S74). In other words, the timing generator 40 may be configured to calculate X-Y coordinates on the screen 31 on which the touch is generated using information about the scattering lights input in the time division scheme to recognize generation of the touch, and may be configured to transfer a command with respect to a function represented by an image of a corresponding touched point to an Electric Control Unit (ECU).

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the accompanying claims.

What is claimed is:

1. A display device configured to recognize touch comprising:
a screen;
a visible light generator controlled by a processor to project a predetermined image with visible light to the screen;
an infrared light generator controlled by the processor to generate scattering light according to user touch with an infrared light source;
a projector controlled by the processor to project the visible light from the visible light generator and the infrared light source from the infrared light generator to the screen; and
an optical sensor controlled by the processor to detect the scattering light.

2. The display device of claim 1, wherein the visible light and the infrared light source are input to the projector through a beam splitter.

3. The display device of claim 1, wherein the infrared light source is executed by the processor to scan the screen at a predetermined time interval to generate the scattering light at a touched point of a user.

4. The display device of claim 1, wherein the projector comprises a timing generator controlled by the processor to calculate a plurality of coordinates on the screen of the scattering light detected by the optical sensor.

5. The display device of claim 4, wherein the scattering light is detected by the timing generator in a time division scheme.

6. The display device of claim 1, wherein a peripheral line of the screen comprises a straight line or a curved line.

7. The display device of claim 1, wherein the display device is mounted within a vehicle.

8. A method of recognizing touch using a display device configured to recognize touch, the method comprising:
projecting, by a processor, a predetermined image to a screen with visible light;
generating, by the processor, scattering light at a touched point of a user by scanning through an infrared light source;
detecting, by the processor, the scattering light using an optical sensor; and
calculating, by the processor, a plurality of coordinates on the screen of the scattering light to recognize the touched point by a timing generator.

9. A non-transitory computer readable medium containing program instructions executed by a processor, the computer readable medium comprising:
program instructions that project a predetermined image to a screen with visible light;
program instructions that generate scattering light at a touched point of a user by scanning through an infrared light source;
program instructions that detect the scattering light using an optical sensor; and
program instructions that calculate a plurality of coordinates on the screen of the scattering light to recognize the touched point by a timing generator.

10. A system configured to recognize touch, comprising:
a controller configured to recognize touch;
a memory configured to store one or more program instructions; and
a processor configured to execute the one or more program instructions, including:
program instructions that project a predetermined image to a screen with visible light;
program instructions that generate scattering light at a touched point of a user by scanning through an infrared light source;
program instructions that detect the scattering light using an optical sensor; and
program instructions that calculate a plurality of coordinates on the screen of the scattering light to recognize the touched point by a timing generator.
